(19) United States
(12) Patent Application Publication
(10) Pub. No.: US 2024/0365717 A1
(43) Pub. Date: Nov. 7, 2024

(54) TANGENTIAL FLOW MATERIAL PROCESSING CHAMBER AND ASSOCIATED MATERIAL PROCESSING SYSTEM

(71) Applicant: Seed Terminator Holdings Pty Ltd, Kingscote, South Australia (AU)

(72) Inventors: Nicholas Kane Berry, Kingscote, South Australia (AU); James Barr, Kingscote, South Australia (AU)

(73) Assignee: Seed Terminator Holdings Pty Ltd, Kingscote, South Australia (AU)

(21) Appl. No.: 18/686,040

(22) PCT Filed: Aug. 25, 2022
(86) PCT No.: PCT/AU2022/051037

§ 371 Date: Feb. 23, 2024

(30) Foreign Application Priority Data
Aug. 25, 2021 (AU) 2021221797

(51) Int. Cl. A01F 29/09

(52) U.S. Cl. CPC A01F 29/09

(57) ABSTRACT

A tangential feed material processing chamber for a material processing system has an axis, an axially extending inlet opening, and an axially extending outlet opening which is circumferentially spaced from the inlet opening. An inner surface of the chamber has a first portion extending circumferentially from a first side of the inlet opening to a first side of the outlet opening, and a second portion extending from a second side of inlet opening to a second side of the outlet opening. The first and second surface portions are formed with different surface finishes. A rotor is mounted along the axis to impact and direct material entering the inlet to flow tangentially about the axis to the outlet. A material processing system is also provided.

### TECHNICAL FIELD

A tangential flow material processing chamber and associated material processing system are disclosed. The chamber and system may have applications for processing weed seeds including those contained in chaff. In such an application the chamber and system can be mounted on a combine harvester to process weed seeds simultaneously with harvesting a crop.

### BACKGROUND ART

Weeds and weed control are, and always have been, one of the biggest constraints and costs to grain production. Weeds are a perpetual problem that limits the food production capacity of agricultural areas around the globe. Weeds compete with the cultivated crops for water, sunlight and nutrients. In the past 50 years there has been a shift from tillage, to the use of herbicides, as being the most valuable tool to control weeds. Herbicides in general give much better control of weeds than tillage methods and do not have the major issues of soil erosion, moisture loss and breakdown of soil structure. The widespread use and reliance of herbicides has resulted in weeds evolving resistance to herbicides. The herbicide resistance is now widespread and presents one of the biggest threats to global food security. Strategies to provide non-chemical weed control to complement herbicides are now paramount to reduce the selection pressure for herbicide resistance. One method of significant renewed interest is destroying weed seeds at harvest time to interrupt the weed cycle.

Many crop weeds share a similar life cycle to harvested crops. Once a crop matures and is harvested, there is a broad range of weeds that have viable seeds remaining on the plant above the cutting height of the harvester. These weeds enter the harvester and their seeds either end up in a grain tank, out with straw residues, or out with chaff residues. There is a range of factors that determine where a weed seed will end up at harvest time including moisture content, maturity, and harvester setup. A major factor that determines where a seed ends up is the aerodynamic properties of the seeds or its terminal velocity. Often a weed seed is much lighter than the grain being harvested. Crop cleaning systems used during harvesting employ a winnowing action to remove light chaff material from the heavier grain using airflow and mechanical sieving. The light weed seeds are caught in the wind and can exit the back of the harvester sieve. The residues and contained weed seeds are then spread on the ground to be a problem for next year. The residues also contain a proportion of grain being harvested that could not be separated by the harvester. This grain loss has the potential to become a volunteer weed after harvest. There is an opportunity to intercept and destroy weed seeds in the residues before allowing them to become a problem for next year's crop.

One method to destroy these weed seeds is to use a milling technology. Milling technology has been used for particle size reduction of a range of feedstock for over a century. Milling technology can be separated into crushing and impact technology.

The most common crushing size reduction technology is the roller mill. Roller mills have been investigated for the purpose of destroying weed seeds at harvest time. Roy and Bailey (1969) U.S. Pat. No. 3,448,933 describe a roller shear mill for destroying weed seeds out of clean grain screenings. Reyenga (1991) U.S. Pat. No. 5,059,154 describes using a separating device and roller mill to crush foreign matter such as weed seeds. A limitation of the roller mill is the ability to handle the bulk of residue material that contains the weed seeds and thus rely on a separation means to reduce the residue material.

Impact mills use high impact speeds generated by rotating elements to pulverise material. Impact mills have also been of interest for the destruction of weed seeds at harvest.

A widely used type of impact mill is a hammer mill, which uses a rotor with impact elements to pulverise material and a screen to classify the output size distribution. Hammer mills are highly versatile and can accept a wide range of feed materials. Plant material such as crop residues is fibrous and difficult to process. The use of hammer mills to devitalise weed seeds in crop residues has been well documented. The use of hammer mills onboard a harvester to devitalise weed seeds has been subject of multiple patents (e.g., Wallis (1995) AU1996071759 Bernard (1998) FR2776468B1).

An advantage of hammer mills is that in addition to impact, they induce crushing, shear and attrition forces that make them particularly useful for size reduction of fibrous materials. Another advantage of hammer mills is that they often have flexible impact elements that are replaceable and can handle some foreign objects without damage.

A further advantage of the hammer mill is that the screen size controls particle fineness and can then control the proportion of weed devitalisation. Control of output size distribution is particularly valuable in the processing of crop residues where material type and moisture conditions change significantly. Change in material conditions result in still similar output size distribution and weed material processing remains less dependent on material conditions than would be without the use of screens.

A disadvantage of current hammer mills is that the screen which controls particle size distribution determines throughput capacity. In general, to devitalise weed seeds a small screen size is required and hence throughput capacity is limited. A hammer mill with concentric screens of varying sizes has been described by Emmanouilidis (1951) U.S. Pat. No. 2,557,865. The Emmanouilidis mill has a central impact zone and additional screens are used to separate output material into different size fractions. The inner primary zone in the Emmanouilidis mill still dictates capacity and overall size reduction.

A different type of impact mill is a cage mill. A cage mill applies predominantly impact forces and level of size reduction is set through rotational speed and the number of concentric rows of bars. There is no classification of particle size with a cage mill. The impact forces in a cage mill make them suitable for friable or brittle materials and are not widely used for processing fibrous materials. However, one example is described in AU 2001/038781 (Zani) which is proposed for destruction of weed seeds. The Zani cage mill has concentric rows of impact elements supported by a ring. The mill is driven at high impact speed to destroy weed seeds. The arrangement can be neatly integrated into the harvester. The arrangement however has limited capacity and cannot process the entire chaff residue fraction exiting the harvester's sieve. Therefore, the Zani system relies on sieving to concentrate the weed seeds for processing.

An increased capacity cage mill is described in WO 2009/100500 (Harrington) to handle the whole chaff material fraction to destroy weed seeds. The Harrington mill uses a large counter rotating cage mill that has fan blades similar to Tjumanok et al 1989 (U.S. Pat. No. 4,813,619) to increase airflow and capacity. This cage mill is large, heavy, requires a complex counter rotating drive and requires considerable power to operate. The system has its own power package and is towed behind the grain harvester. The size, weight and drive, limits options to integrate the cage mill into the harvester. The mill incorporates cylindrical bars that limit impact speeds because of glancing blows. The impact speed therefore has a large distribution. To get sufficient impact energy into weed seeds requires counter rotation of the cage structures.

A further mill for destroying weed seeds is described in PCT/AU2014/218502 (Berry Saunders). Berry Saunders uses a rotor stator cage mill that is much simpler to integrate into a grain harvester than the counter rotation systems. The Berry Saunders mill provides an advance on the Zani cage mill by improving the throughput capacity and seed kill performance of the mill system. It achieves this by using a central distribution element (also described in Isaak (2003) DE 10203502) and angular static bars that are slanted against the rotation of the rotor. A purportedly novel aspect of the Berry Saunders mill is that the spacing between the angled impact bars determines if a seed will pass through to the next row of impact bars or stay within the current row of impact bars. The size of the seed does not determine if it passes through the row of impact bars or remains.

The relatively simple workings of cage mills which apply predominantly impact and do not use size classification has enabled computer modelling techniques to be used to predict mill performance. The Berry Saunders mill has been optimised using computer modelling techniques to apply the ideal requirements to devitalise weed seeds using impact alone. However, there has been little concern for the airflow component of the power consumption. The rotor bars are narrow with sharp edges resulting in high drag coefficient and turbulence generation. The stator bars are orientated to result in a torque converter or water brake dynamometer like turbulence generation and wasted heat generation.

One disadvantage of this approach is that the stator impact bars take up a lot of space radially. This in turns means that adjacent rows of rotating impact bars are spaced a long way apart. For a weed seed devitalisation mill, or a particle destruction mill for that matter, impact speed is crucial. When impact bars are spaced widely apart the impact speed difference between each subsequent row is significant.

A different configuration of seed devitalisation apparatus is described in Applicant's international publication number WO2021/077180. This apparatus is in the form of a barrel with a rotary impact mechanism mounted along a barrel axis for impacting chaff onto a textured inner surface of the barrel. The barrel as inlets at opposite ends and an outlet circumferentially spaced from inlets and disposed axially between the inlets. Chaff enters through the inlets from opposite ends and is moved in a spiral path about an axis by action of the impact mechanism and form of surface texture and discharged through the outlet.

The above references to the background art do not constitute an admission that the art forms a part of the common general knowledge of a person of ordinary skill in the art. The above references are also not intended to limit the application of the material processing chamber and associated material processing system as disclosed herein.

### SUMMARY OF THE DISCLOSURE

In a first aspect there is disclosed a tangential flow material processing chamber for a material processing system comprising:
a chamber having an axis, an inner surface, opposite ends, an inlet opening extending for a full axial length of the chamber between the opposite ends, and an axially extending outlet opening which is circumferentially spaced from the inlet opening;
wherein material entering the inlet opening flows substantially tangentially about the axis towards the outlet opening.

In one embodiment the chamber comprises a bypass door located between the inlet and the outlet, wherein the bypass door is movable between a first position and a second position, wherein when in the first position the bypass door acts to direct material entering from the inlet toward the outlet, and when in the second position the bypass door opens a bypass outlet through which the material can flow out of the chamber.

In one embodiment the chamber comprises an inner surface with a textured first surface portion extending circumferentially between the inlet and the outlet.

In one embodiment at least a part of the textured first surface portion is formed on an inside surface of the bypass door.

In one embodiment the textured first surface portion comprises (a) a plurality of valleys or protrusions or both valleys and protrusions; or (b) alternating ridges and grooves; or (c) a wave like pattern of alternating crests and troughs when view in an axial direction.

In one embodiment the chamber comprises a screen extending across the outlet opening the screen having a plurality of holes through which a fraction of the material of a size sufficiently small to pass through the holes is able to pass through the screen and the outlet.

In a second aspect there is disclosed a tangential flow material processing chamber for a material processing system comprising:
an axis, an axially extending inlet opening, an axially extending outlet opening which is circumferentially spaced from the inlet opening;
an inner surface with a first surface portion extending circumferentially from a first side of the inlet opening to a first side of the outlet opening, and a second surface portion extending from a second side of inlet opening to a second side of the outlet opening;
wherein the first and second surface portions are formed with different surface finishes, and material entering the inlet opening flows tangentially about the axis.

In one embodiment the first surface portion is a textured surface so that when the first and second surface portions are of equal radius then for the same arc length the first surface portion has a greater surface area than the second surface portion.

In one embodiment the textured surface comprises (a) a plurality of valleys or protrusions or both valleys and protrusions; or (b) alternating ridges and grooves; or (c) a wave like pattern of alternating crests and troughs when view in an axial direction.

In one embodiment the second surface is smoother than the first portion of the inner surface.

In one embodiment a radial distance between the axis and first surface portion is greater than a radial distance between the axis and the second surface portion.

In a third aspect there is disclosed a tangential flow material processing chamber for a material processing system comprising:
an axis, an axially extending inlet opening, an axially extending outlet opening which is circumferentially spaced from the inlet opening;
an inner surface with a first surface portion extending circumferentially from a first side of the inlet opening to a first side of the outlet opening, and a second surface portion extending from a second side of inlet opening to a second side of the outlet opening;
wherein the first surface portion and the second surface portion are spaced by radii Rd1 and Rd2 respectively from the axis wherein Rd1>Rd2, and material entering the inlet opening flows tangentially about the axis to the outlet opening.

In one embodiment the first surface portion is capable of being pivoted about the axis.

In one embodiment the first surface portion is capable of being moved linearly toward or away from the axis a radius of the chamber.

In one embodiment the second surface portion is capable of being pivoted about the axis.

In one embodiment the first surface portion is capable of being moved linearly toward or away from the axis a radius of the chamber.

In one embodiment the chamber comprises a bypass door located upstream of the first surface portion with reference to a direction of flow of material from the inlet to the outlet, wherein the bypass door is movable between a closed position and an open position, wherein when in the closed position the bypass door acts to direct material entering from the inlet opening toward the first surface portion, and when in the open position the bypass door opens a bypass outlet in the chamber upstream of the first surface portion through which the material can flow out of the chamber.

In a fourth aspect there is disclosed a material processing machine comprising a tangential flow material processing chamber according to any one of the first to third aspects and a rotor rotatably supported to rotate about the axis, the rotor arranged to: impact material entering the inlet opening and accelerate the material toward the inner surface; and, facilitate a flow of material toward the outlet opening.

In one embodiment the rotor comprises a shaft and a plurality of hammers or flails coupled to the shaft.

In a fifth aspect there is disclosed a material processing system comprising at least two material processing machines according to the fourth aspect, wherein the chambers of the machines are arranged parallel to each other with an outlet opening of a chamber of a first machine coincident with an inlet opening of a chamber of a second machine and forming a common opening through which material from the first machine can pass to the second machine; and wherein the inlet opening of the first machine forms an inlet of the material processing system, and the outlet of the second machine forms the outlet of the material processing system.

In one embodiment the rotors of the respective machines rotate in opposite directions.

In one embodiment the material processing system comprises a screen extending across the common opening, the screen provided with a plurality of holes through which a fraction of the material of a size sufficiently small to pass through the holes is able to pass through the screen and common opening into the second machine.

In one embodiment wherein the rotors of the respective machines rotate in the same direction.

In a sixth aspect there is disclosed a combine harvester having an engine and a separation system for separating a harvested crop into a first material stream comprising straw and a second material stream comprising chaff and weed seeds, the combine harvester comprising: a material processing machine according to the fourth aspect wherein the second material stream is directed to flow into the inlet of the material processing system; and a drive system for transferring drive from the motor to the impact mechanisms of the material processing system to cause rotation of the impact mechanisms.

In one embodiment the combine harvester comprises a straw chopper arranged to chop straw in the first material stream and wherein the drive system is operable to provide drive to the chopper.

In a seventh aspect there is disclosed a combine harvester having an engine and a separation system for separating a harvested crop into a first material stream comprising straw and a second material stream comprising chaff and weed seeds, the combine harvester comprising: a material processing system according to the fifth aspect wherein the second stream of the material is directed to flow into the inlet of the material processing system; and a drive system for transferring drive from the motor to the rotors of the material processing system to cause rotation of the rotors.

In one embodiment the drive system comprises a shaft which derives power from the engine and a belt and pulley arrangement having one or more belts and one or more pulleys for transferring drive from the shaft to the rotors.

In one embodiment the drive system is arranged to cause rotation of the rotors in opposite directions.

In one embodiment the drive system is arranged to cause rotation of the rotors in the same direction.

In one embodiment the combine harvester further comprises a straw processing system capable of processing the first material stream and discharging a processed first material stream from a discharge location; and wherein the drive transfer system is arranged to transfer drive from the engine to the straw processing system.

In one embodiment drive transfer system comprises at least one belt arranged to transfer drive from the straw processing system to the material processing system.

In one embodiment the outlet opening of the material processing system is arranged to discharge material from a location beneath the discharge location of the straw processing system.

In one embodiment the bypass door is movable to the second position to cause the second material stream to feed into the straw processing system and bypass processing against the first surface portions.

In one embodiment the combine harvester comprises an actuator operable from a cab of the combine for moving the bypass door between the open and closed positions.

In one embodiment the straw processing system comprises a straw chopper and a straw spreader.

In one embodiment the combine harvester comprises a drive disengagement mechanism arranged to selectively disengage transmission of drive from the engine to the rotors.

In one embodiment the combine harvester comprises a drive disengagement mechanism arranged to selectively disengage transmission of drive from the engine to the rotors while maintaining transmission of drive to the straw processing system.

In an eighth aspect there is disclosed a material processing system comprising:
a first chamber, and a second chamber, an inlet opening to the first chamber, a common opening enabling material to flow from the first chamber to the second chamber, and an outlet opening in the second chamber downstream of the inlet opening and the common opening;
a first rotor rotatably supported about a first axis in the first chamber;
a second rotor rotatably supported about a second axis in the second chamber, wherein the first axis is parallel to the second axis;
wherein material entering the inlet opening is directed to flow tangentially about the first axis by action of the first rotor toward the common opening, and material passing through the common opening into the second chamber is directed to flow in a tangential direction about the second axis by the action of the second rotor to the outlet opening.

In one embodiment the second chamber has an inner surface, the inner surface having a textured first surface portion which for a selected arc length about, and radius from, the second axis, has a greater surface area than a sector of the inner surface of the second chamber of the same arc length and radius.

In one embodiment the first chamber has an inner surface, inner surface having a textured first surface portion which for a selected arc length about, and radius from, the first axis, has a greater surface area than a sector of the inner surface of the first chamber of the same arc length and radius.

In one embodiment the textured first surface portion is formed with (a) a plurality of valleys or protrusions or both valleys and protrusions; or (b) alternating ridges and grooves; or (c) a wave like pattern of alternating crests and troughs when view in an axial direction.

In one embodiment the first chamber has a smooth surface.

In one embodiment the material processing comprises a screen extending across the common opening, the screen configured to enable particles in the material of a first size to pass through the common opening to the second chamber.

In one embodiment the screen is adjustable to enable a user selectable fraction of material to pass through the screen to the second chamber.

In one embodiment the first chamber includes a bypass door movable between a first position enabling the material to continue to travel tangentially about the first axis, and a second position enabling a fraction of the material remaining within the first chamber after passage across the common opening, to exit the first chamber.

In one embodiment the first chamber includes a bypass opening downstream of the first outlet opening through which material that travels across the screen without falling to the second chamber is discharged from the first chamber.

In a ninth aspect there is disclosed a material processing system comprising a first chamber having an axis, an axially extending first inlet opening, an axially extending first outlet opening which is circumferentially spaced from the first inlet opening;
the first chamber also having an inner surface with a first surface portion extending circumferentially from a first side of the first inlet opening to a first side of the first outlet opening, and a second portion extending from a second side of first inlet opening to a second side of the second outlet opening; and
a second chamber having an axis, an axially extending second inlet opening, an axially extending second outlet opening which is circumferentially spaced from the second inlet opening;
the second chamber also having an inner surface with a first surface portion extending circumferentially from a first side of the second inlet opening to a first side of the second outlet opening, and a second surface portion extending from a second side of second inlet opening to a second side of the second outlet opening;
wherein the first and second chambers are parallel to each other with the first outlet opening coincident with the second inlet opening and forming a common opening through which material from the chamber can pass to the second chamber.

In one embodiment the material processing system comprises a screen located across the common opening, wherein material of a size smaller than a mesh size of the screen passes from the first chamber to the second chamber.

In one embodiment the first and second surface portions of the inside surface of either one or both of the first and second chambers is formed with different surface finishes.

In one embodiment the first surface portion of inner surface is a textured surface so that when the first and second surface portions are of equal radius then for the same arc length the first surface portion has a greater surface area than the second surface portion.

In one embodiment for either one or both of the first and second chambers, a radial distance between the axis and first surface portion of the inner surface is greater than a radial distance between the axis and the second surface portion of the inner surface.

In one embodiment the material processing system comprises, for both the first and second chambers, respective rotors, each rotor rotatably supported to rotate about the axis of a correspond chamber, the rotors arranged to: impact material entering the inlet opening of that chamber and accelerate the material toward the first portion of the inner surface; and facilitate a flow of material toward the outlet opening of that chamber.

In one embodiment the material processing system comprises a first rotor rotatably supported to rotate about the axis of the first chamber, and a second rotor rotatably supported to rotate about the axis of the second, the first rotor arranged to advance material entering the first inlet opening toward the common opening and the second rotor arranged to advance the material entering the second chamber through the common opening toward the second outlet opening.

In one embodiment the second rotor is arranged to impact material entering through the common outlet and accelerate the material onto the first surface portion of the second chamber.

In one embodiment the first chamber includes a bypass opening downstream of the first outlet opening through which material that travels across the screen without falling to the second chamber is discharged from the first chamber.

In one embodiment the material processing system comprises a bypass door, wherein the bypass door is movable between a first position and a second position, wherein when in the first position the bypass door acts to retain material to flow tangentially about the axis of the first chamber, and when in the second position the bypass door opens a bypass outlet in the first chamber through which the material can flow out of the first chamber.

### BRIEF DESCRIPTION OF THE DRAWINGS

Notwithstanding any other forms which may fall within the scope of the material processing chamber, machine and material processing system as set forth in the Summary, specific embodiments will now be described, by way of example only, with reference to becoming drawings in which:

FIG. 1 is a perspective view of a first embodiment of two of the disclosed tangential flow material processing chambers juxtaposed to work together and form an associated material processing system, and where a bypass door on an upper one of the chambers is shown in a closed position where to bypass door directs material entering the material processing system to flow toward an outlet of the material processing system;

FIG. 2 is a side view of the chambers shown in FIG. 1;

FIG. 3 is a side view of the chambers shown in FIGS. 1 and 2 but with end plates removed;

FIG. 4 is a side view of the chambers shown in FIG. 3 but with the bypass door in the upper chamber in an open position allowing material entering the inlet of the material processing system to flow out of a bypass opening flows in the upper chamber prior to any substantive processing;

FIG. 5 is a laid-out view of a first surface portion of an inner surface of one embodiment of the chambers showing a textured surface finish;

FIG. 6 is an enlarged view of the textured finish on the first surface portion shown in FIG. 5;

FIG. 7 is a section view of the first surface portion shown in FIG. 5;

FIG. 8 is a laid-out view of a first surface portion of a further embodiment of the disclosed chamber;

FIG. 9 is a view of section A-A shown in FIG. 8;

FIG. 10 is a representation of an embodiment of the disclosed chamber and associated material processing system with a bypass door open and shown mounted adjacent to a straw processing system on a combine harvester;

FIG. 11 is a representation of another embodiment of the disclosed chamber and associated material processing system shown mounted adjacent to a straw processing system on a combine harvester; and

FIG. 12 is a representation of one possible drive system for driving rotors of the material processing system in counter rotating directions.

### DETAILED DESCRIPTION OF SPECIFIC EMBODIMENTS

The following description of embodiments of the disclosed tangential flow material processing chamber 10 and associated material processing machine 12 and system 14 are made in the context of an agricultural application where the chamber 10, machine 12 and system 14 are mounted on a combine harvester. The combine harvester separates a harvested crop into target seeds/grain; straw; and chaff. For a crop harvested by a combine harvester the chaff may comprise a combination of small portions of straw, target grain husks and seeds from weeds or volunteers. The straw may be processed by a straw processing system that may include a straw chopper. The chaff travels along a sieve in the combine, thought which target gain drops. The chamber 10, machine 12 and system 14 process the chaff falling off an end of the sieve while the combine is harvesting the crop. The processing by the chamber includes devitalising seeds (for example, but not limited to weed seeds) in the chaff.

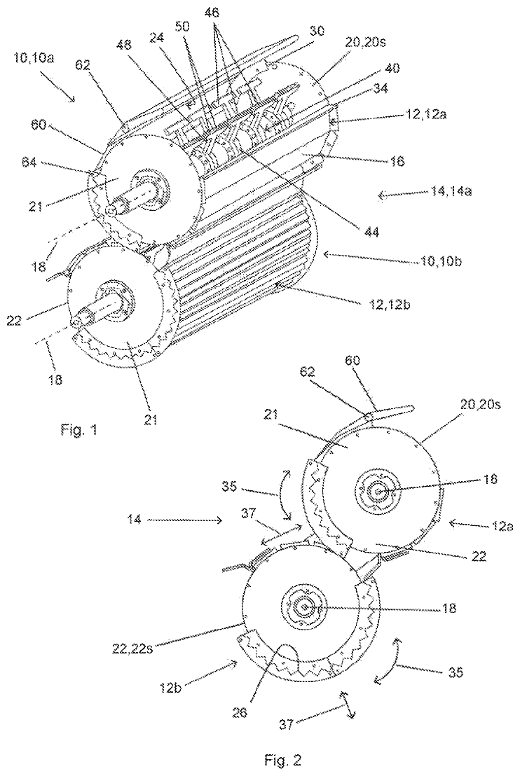

FIG. 1 shows two of the disclosed chambers 10a and 10b, which are denoted in general as “chamber 10” or “chambers 10”. Each chamber 10 is incorporated in a corresponding processing machine 12a, 12b (referred to in general as “machine 12” or “machines 12”). In this embodiment two chambers 10, and corresponding processing machines 12, work together to form a processing system, which in general is denoted as 14, but specific embodiments described hereinafter are designated as 14a or 14b). The chambers 10a and 10b in this, but not every embodiment, are similar in terms of their construction and configuration. Though, as explained later there are, or can be, differences.

In the following description the same reference numbers are used to denote identical substantially similar features of the chambers 10a, and 10b. In some instances, for ease of differentiating a feature of one of the chambers 10a, 10b from the same feature of the other chamber 10a, 10b the suffix “a” is used to denote the features of the chamber 10a, while the suffix “b” is used to denote the features of the chamber 10b

The tangential flow material processing chamber 10a comprises a drum like body 16 having an axis 18, an axially extending inlet opening 20 and an axially extending outlet opening 22 which is circumferentially spaced from the inlet opening 20. The body 16 is substantially cylindrical and closed at opposite ends by end plates 21. The inlet opening 20 may extend for substantially the full axial length of the body 16. Moreover, the chamber 10a can be dimensioned so that the length of the inlet 20 is substantially the same as a width of the sieve of the combine on which the chamber 10a is mounted. Thus, in such an embodiment the width of the inlet opening 20 is substantially the same as the width of the sieve. But in other embodiments if there is an intervening part of the combine that changes (i.e., narrows or indeed spreads) the width of the chaff stream from the sieve prior to entering the inlet 20, then a chamber 10a and/or the chamber inlet opening 20 can be designed to substantially match the width of the chaff stream flowing into the chamber 10a.

The outlet opening 22 may also extend for substantially the full axial length of the body 16, though for some embodiments the outlet opening may be narrower for example to fit the feed of downstream equipment such as spreaders. The term “tangential flow” is used throughout this specification to describe the direction of flow of material from the inlet opening 20 to the outlet opening 22 relative to the axis 18. Equally the direction of flow of material can also be considered to be described as “circumferential” in that the material flows in a circumferential direction about the axis 18. Throughout this specification the terminology “tangential flow” and “circumferential flow” may be used interchangeably to describe the same direction of material flow.

When the length of the inlet 20 is substantially the same as a width of the combine sieve or chaff feed stream entering the chamber 10a, the material (i.e., chaff) flows into and is processed the chamber 10, machine 12 and system 14 in same direction as it leaves the sieve. The chaff continues to flow as a sheet of particles of substantial constant width, with primarily tangential flow about the axis 18 as distinct from axial motion along the axis 18. Therefore, there is less particle to particle interaction resulting in more seed damage and more capacity.

An inner surface 24 of the body 16 of the chamber 10a has a first surface portion 26, and a second surface portion 28. The first surface portion 26 extends circumferentially between a first side 30 of the inlet opening 20 to a first side 32 of the outlet opening 22. The second surface portion 28 extends between a second side 34 of inlet opening to a second side 36 of the outlet opening 22. The first and second surface portions 26, 28 may be formed with different surface finishes. When the surface finishes are different the chamber 10a may be considered to be a “multi-surface” chamber, i.e., because it has two portions of different surface finish.

The first surface portion 26 is formed with a textured surface, the second surface portion 28 being of a smoother finish. Indeed, most conveniently the second surface portion 28 may be smooth. Stated another way, the first surface portion is rougher than the first surface portion. The idea or purpose of the textured surface is to create edges, corners or surface irregularities against which material entering the chamber 10 from the inlet opening 20 is impacted to enhance damage and thus cause devitalisation of weed seeds contained in the material. The devitalisation may be achieved by one or more of particle size reduction, fragmentation, fracturing, crushing and milling of the seeds due to impact against at least the surface portion 26.

As the second surface portion 28 is downstream of the outlet 22 with reference to the tangential direction about the axis 18, substantially no material is carried across the outlet 22 to the second surface 28. Hence, there is no need to arrange the chamber 10/machine 12 to be able to cause devitalisation across the surface portion 28. For this reason, the surface portion 28 does not need texturing and can remain relatively smooth. This reduces the cost of construction of the chamber 10.

In this embodiment both of the surface portions 26 and 28 are impervious. Therefore, material entering the chamber 10 cannot pass through either of the surface portions 26 or 28. Rather the material is contained within the chamber 10a as it passes across the surface portion 26 from the inlet to the outlet.

Another differentiating feature between the first surface portion 26 and the second surface portion 28 is their respective distance from the axis 18. The radial distance Rd1 between the axis 18 and the first surface portion 26 is greater than the radial distance Rd2 between the axis 18 and the second surface portion 28. A cut off plate 29 (shown in FIG. 2) may be provided in the chamber 10a where the smaller radius Rd 2 starts with reference to the direction of material flow begins. A replaceable wear part may be supported by the plate 29. As material moves around the chamber 10a it then runs into the plate 29/wear part that directs it into the second chamber 10b. The difference in the radial distance of the surface portions 26 and 28 from the axis 18 is another way in which the chamber can be considered to be a “multi-surface” chamber.

In one embodiment the texturing of the first surface portion 26 may be in the form of a plurality of ridges or ribs 38 that extend along the first surface portion 26 parallel with the axis 18. The ribs 38 are spaced apart in a circumferential direction forming a wave like pattern or configuration on the surface portion 26 when viewed in the axial direction. The wave like pattern can include a square wave, a sawtooth pattern with one sloping side and one upright side, a sawtooth with two opposed and converging sides, or radiused ridges and crests.

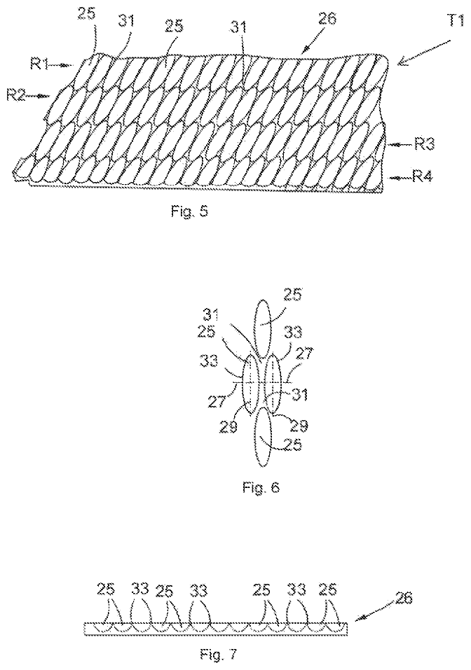

In an alternate embodiment the texturing of the first surface portion 26 may be by providing a plurality of surface reliefs such as valleys, pits or grooves and/or surface elevations such as ridges, ribs, bumps, protrusions and projections; or other irregularities. FIGS. 5-7 show the first surface portion 26 in a laid flat condition with one possible texturing pattern T1. The first surface portion 26 comprises a plurality of the valleys 25. At least some of the valleys 25 have two orthogonal axes 27 and 29 of unequal length. A shorter of the orthogonal axes 27 extends in a circumferential direction with respect to the rotation axis 18. A longer of the orthogonal axes 29 extends parallel to the rotation axis 18. Yet in other embodiments the axis 29 can be oblique to the axis of rotation 18. Having the axes 27 and 29 of unequal length provides the valleys 25 with a generally elliptical shape.

Between the valleys 25, the surface 26 as a plurality of lands 31 that are “flat” with respect to the axis of rotation 18 so that every point on the lands 31 lie on respective land radii of the same length. That is, if the surface 26 were laid out flat as indeed shown in FIGS. 5-7 all the lands 31 are flat and lay on a common plane. Also, the valleys 25 have edges 33 that lie on respective edge radii of the same length from the rotation axis. Thus, in this configuration the edges 33 all lie on radii of the same length as the those of the lands 31.

The valleys 25 are arranged in a generally uniform pattern of stacked circumferential rows R1, R2, R3, and R4. In rows R1-R3 the valleys 25 have respective axes 29 of the same length. However, in row R4 the valleys are of the shape of a hemi-ellipse and have a shorter axis 29 than in the other rows. The number of rows of valleys on the surface 26 can vary. The ends of the valleys 25 in one row may, as they do in this embodiment, lie between the ends of adjacent valleys in an adjacent row.

When the surface 26 is used in relation to chaff it is believed that it may induce a differential flow of material depending on the material type in the chaff (for example short pieces of straw compared with weed seed) leading to different residence time within the mill. Without wishing to be bound by theory it is believed that straw pieces may flow along the lands 31 and across the edges 33 of the valleys 25, while weed seeds in the chaff may predominantly impact in the valleys 25. Consequently, it is believed that the seeds would travel more slowly and therefore have higher residence time across the surface portion 26 than the straw pieces.

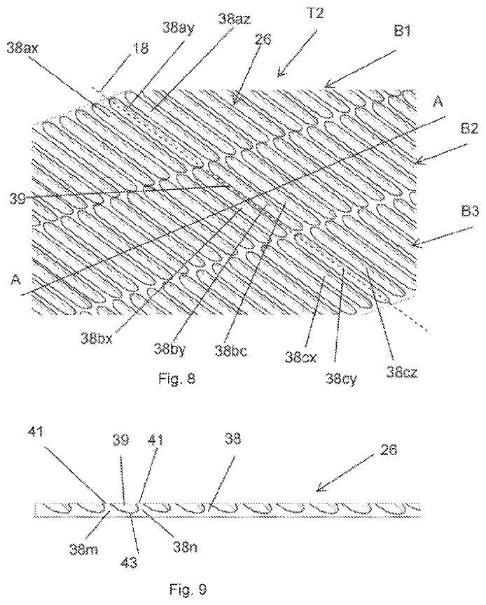

FIGS. 8 and 9 shown a different texturing pattern T2 for the first surface portions. The first surface portion 26 comprises a plurality of ribs 38 that extend parallel to the axis 18. The ribs 38 are arranged in a plurality of bands; in this case three bands Ba, Bb and Bc. In a specific band any rib 38 is circumferentially adjacent and between two other ribs. The ribs of the bands B1, B2 and B3 extend in the direction of the axis 18, but the ribs 38 in adjacent bands are circumferentially offset. For example, referring to FIG. 8 three ribs 38ax, 38ay and 38az have been labelled in the band Ba. Similarly, three ribs 38bx, 38by and 38bz have been labelled in the band Bb and three ribs 38cx, 38cy and 38cz have been labelled in the band Bc. In any band Bi (i=a, b or c), the rib 38iy is circumferentially adjacent and between the ribs 38ix and 38iz. Also, the ribs 38ax, 38ay and 38az in the band Ba are circumferentially offset from 38bx, 38by and 38bz in the band Bb respectively. Stated another way, looking in the direction of the axis 18, the ribs 38 in any band are aligned with valleys 39 between adjacent ribs in an adjacent band.

As seen in FIG. 9 the ribs 38 have a wave like profile spaced by valleys 39. The valleys a non-symmetrical profile with a relatively long linear slope from one a crest 41 of a first rib 38m to curved trough 43 which is closer to an adjacent rib 38n. The valley 39 then curves up to the rib 38n.

Due to the texturing of the surface portion 26, for any given arc length about the axis 18, and assuming an equal radial distance from the axis 18 for surface portions 26 and 28, the surface area of the surface portion 26 is greater than that of the surface portion 28. For example, for a 30° arc about the axis 18, surface portion 26 has a greater surface area than a 30° arc of the surface portion 28.

The chamber 10a may be arranged to enable the surface portion 26 to be moved in one or both of: a pivoting motion about the axis 18; and, linearly (i.e., along a radius) relative to the axis 18. The pivoting motion is shown by arrow 35 in FIG. 2. The pivoting motion may be used to control the size of the outlet opening 22. For example, with reference to FIG. 2 pivoting the surface 26 of chamber 10a in an anti-clockwise direction will reduce the size of the outlet opening 22, increasing residence time of the material. Pivoting motion in the clockwise direction will increase the size of the opening. The linear motion of the surface portion 26 is shown by arrow 37 in FIG. 2. Moving the surface portion 26 linearly to vary the radial distance from axis 18 can be used to change the degree or percentage of the devitalisation of weed seeds.

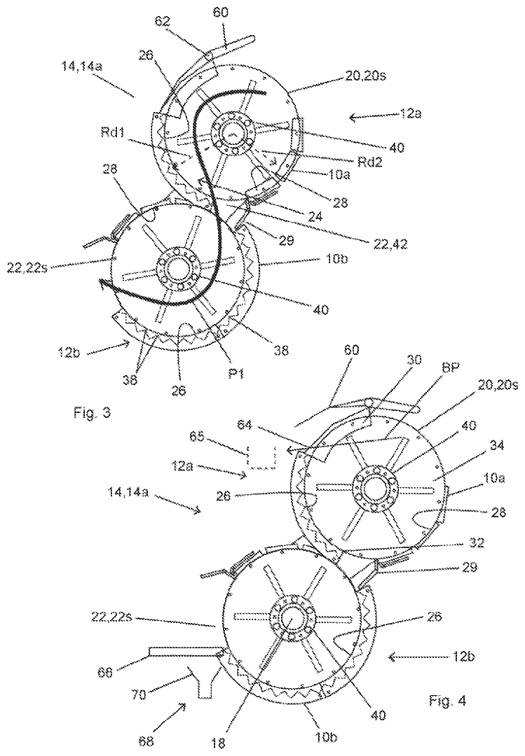

In some embodiments the surface portion 26 may include two or more separate parts telescopically extendable/retraceable relative to each other in the circumferential direction. The effect of this is to vary the path length of the chaff across the surface portion 26. This is may be used to vary the degree of processing of the chaff and entrained weed seeds. Looking at the chamber 10a in FIG. 3, the surface portion 26 extends for about 90° about the axis 18. The surface 26 could be formed of two parts, a first extending for 90° and a second part that extends for 15°. The second part may be arranged to slide between a fully retracted position where it wholly lies beneath the first part. The second part is formed with an impact surface facing the axis 18. In the fully retracted position, a downstream edge of the second part can be located in substantial alignment with a downstream edge of the first part which forms an edge of the outlet opening 22. In a fully extended position, the second part slides so that its downstream edge moves into, and indeed narrows the arc length of, the outlet opening 22, and exposing its impact surface. The result is that the impact surface portion 26 now extends for 105° about the axis 18.

This allows variability of total area and length of the impact surface portion 26 and thus provides a further mechanism to tune the chamber 10a to the nature of the chaff and weed seeds being presented for processing. This construction also provides a mechanism for changing the area and arc length of the opening 22.

In yet a further variation the surface portion 26 may also be provided with a third part similar in form to the second part, but arranged to extend from, and retract under, a leading or upstream edge of the first part. With this arrangement the impact surface portion 26 can be extended in one or both of an upstream direction and a downstream direction independently of each other.

A rotor 40 is rotatably supported to rotate about the axis 18 within the chamber 10a. The rotor 40 comprises a shaft 44 that is coincident with the axis 18. The rotor 40 has a plurality of radially extending members 46 and assist in advancing the material from the inlet 20 toward the outlet 22. The members 46 may take different forms depending on their intended effect(s). For example, as in the present embodiment, the intended effect is to impact weed seeds in the chaff for the purposes of devitalising by the combination of being impacted directly by the members 46, and being accelerated onto and therefore impacted against the inner surface of the chamber 10a. The meet these intended effects the members are in the form of hammers or flails 46, that are coupled to the shaft 44 and extend in a generally radially outward direction.

Due to the differences in the radial distances Rd1 and Rd2 (FIG. 3) a radially distant end of the hammers or flails 46 pass closer to the second surface 28 and the first surface 26. Also, the rotor 40 is driven to rotate in a direction so as to direct material entering through the inlet opening 20 toward and onto the surface portion 26. Due to this combination of features an overwhelming proportion of the material entering through the inlet opening 20 is processed against the surface portion 26 with an insignificant volume of material flowing across the second surface portion 28. The rotor 40 comprising the shaft 44 and hammers/flails 46 may be termed or designated as an impact mechanism 40.

Each flail 46 has a radially outer edge 48 located with a small clearance from the second surface portion 28. The edge 48 may be formed with a plurality of spaced apart grooves or flutes 50. The purpose of the flutes 50 is to assist in fragmenting elongated material such as straw that may enter chamber 10a and reducing smearing of material on the second surface portion 28. Additionally, the flutes 50 may have a combing effect on straw contained in the chaff and thus further assist in creating a differential in motion and/or processing of the straw in comparison to weed seeds contained in the chaff.

The chamber 10a is provided with a bypass door 60. The door 60 is coupled to, or forms part of, the body 16 of the chamber 10a, and can be pivoted about a pivot axis 62. In this embodiment the bypass door 60 is movable between a first or closed position shown in FIGS. 1-3 and a second of open position shown in FIG. 4. The bypass door 60 is controlled to selectively open and close a bypass opening 64 in the chamber body 16. When the bypass door 60 is in the first position, chaff entering through the inlet 20 of the chamber 10a is retained within the chamber body 16 and guided to flow tangentially about axis 18 toward the impact surface portion 26 by action of the rotating rotor 40. The bypass door 60 may be moved between the first and second positions by an actuator controlled or operated from the cab of a combine. Optionally, an inside surface of the bypass door 60, may have the same texture as either one of the first or second surface portions 26, 28. Further the bypass door can be formed as a part of the body 16, for example as a curved plate that can either (a) slide about a remainder of the body 16 to open and close a bypass opening 64, or (b) pivot at one end to open and close a bypass opening 64.

In other embodiments the, or at least a part of the, first surface portion or the second surface portion be configured or to otherwise arranged to operate as the bypass door.

When the bypass door 60 is moved to the second position, chaff entering through the inlet 20 is directed by the rotor 40 to flow out of the bypass opening 64, as shown by path BP in FIG. 4. As a consequence, the chaff is not processed against the impact surface portion 26. The bypassed chaff may be dealt with in a number of different ways including for example:
(a) directed to flow into a straw chopper;
(b) directed into a spreader to be spread together with chopped straw from the straw chopper; or
(c) windrowed.

Optionally, a sampling system 65 may be provided near the bypass opening 64 to receive a sample of the bypassed chaff to facilitate a measure of target grain loss. This is a measure of the target grain that is not captured in upstream grain separation mechanisms including the combine sieve, and is therefore lost in the chaff. The sampling system 65 may be a simple receptacle capturing a sample of the chaff which can then be manually examined for grain loss. Alternately, one or more sensors may be incorporated in the sampling system 65 to provide a measure of grain loss. This may be: indicated on a display in the cab; and/or stored electronically on board the cab; and/or sent electronically to a remote location for logging and analysis.

In this embodiment the bypass opening 64 is up stream of the impact surface portion 26 with reference to the direction of flow of chaff in the chamber 10a. Also, in this embodiment the bypass door 60 is formed with a smooth surface. When in the first position shown in FIGS. 1-3 chaff is impacted against the inside surface of the bypass door 60 by the action of the rotor 40. For this sector of the chamber 10a, processing of the chaff (i.e., devitalisation of seeds within the chaff) is minimal due to the smooth surface of the door 60. However, in other embodiments, where the inside surface of the bypass door 60 is textured the inside surface of the bypass door 60 acts as a part or extension to the impact surface portion 26 thereby increasing the proportion of devitalisation occurring within the chamber 10a.

The chamber 10b is similar the chamber 10a. The main differences in this, but not necessarily every embodiment, are:
a) that the impact surface portion 26 of the chamber 10b is, or at least is able to be, of a longer circumferential length, i.e., extends for a greater angle about axis 18, than the surface portion 26 of the chamber 10a;
b) the chamber 10b does not have a bypass door 60; and
c) the chamber 10b may have an optional movable wall or gate 66 (shown in FIG. 4) that is movable to control the size (i.e., area) of the outlet 22b of the chamber 10b which in turn provides control over the travel speed and mass flow rate through the system 14.

In relation to the relative length of the impact surface portion 26 of the chambers 10a, 10b, if the bypass door 60 is provided with a textured inner surface, then when in the first position the length of the impact surface portion 26 of the chamber 10a is naturally increased by the length of the bypass door. The increase may result in the length of the surface portion 26 of chamber 10a approaching, equaling, or indeed exceeding, the length of the surface portion 26 of the chamber 10b.

Other than the differences described above, the features of the chamber 10b are in substance the same as those of the chamber 10a. A rotor 40 is rotatably supported to rotate about the axis 18 of, and within, the chamber 10b. This has the same structure and operation as the rotor/impact mechanism 40 of the chamber 10a. The first surface portion 26 of the chamber 10b may be arranged to move with one or both of a pivotal motion about, and linear motion toward and away from, the axis 18 of chamber 10b, as shown by arrows 35 and 37 in FIG. 2. Also, the first surface portion 26 of chamber 10b may be made for multiple parts to enable its overall length the be varied as described above in relation to the chamber 10a.

The rotation of the rotor 40 generates a substantial flow of air from the system 14 outlet 22s. As explained later, this air flow, may be used to augment the flow of chopped straw that may be produced by a straw chopper mounted on a combine.

The combination of a chamber 10a and the rotor 40 forms the first material processing machine 12a. The combination of a chamber 10b and the impact mechanism 40 forms the second material processing machine 12a.

The combination of two (or more) material processing machines 12 forms an embodiment of the material processing system 14a. The machines 12a and 12b have their respective chambers 10 arranged parallel to each other with the outlet opening 22 of chamber 10a radially aligned with and adjacent to the inlet opening 20 of the chamber 10b. This forms a common opening 42 through which material flows from the first machine 12a to the second machine 12b. The common opening 42 may have a length substantially the full axial length of the chambers 10.

The system has an outlet opening 22s which is one and the same as the outlet opening 22 of the lower chamber 10b. The outlet opening 22s may extend for substantially the full axial length of the chamber 10b, though for some embodiments the outlet opening 22s may be narrower for example to fit the feed of downstream equipment such as spreaders.

Material is processed against the surface portion 26 of each of the machines 12. For example, if the surface portion 26 of the chamber 10a extend circumferentially for 90° and the surface portion 26 of chamber 10b/machine 12b extends for say 180° then in the arrangement of FIGS. 1-3 the material is in effect processed against a surface extending circumferentially for 270° when the rotor 40 of chambers 10a, and 10b are rotating in opposite directions, in this embodiment being anticlockwise and clockwise directions respectively. Here the chaff follows a serpentine like path P1 (shown in FIG. 3) from the inlet 20s of the system 14a (being the inlet 20 of chamber 10a) to the outlet 22s of the system 14a (being the outlet 22 of chamber 10b).

A sampling system 68 (see FIG. 4) may be associated with the system 14a. The sampling system 68 takes a sample of the chaff processed by the processing system 14a to enable a measure of the percentage of weed seeds in the chaff being devitalised. This in turn can be used to vary, manually or automatically, physical or operation conditions of the processing system 14a. The physical or operational conditions may include for example
a) speed of rotation of the rotors 40;
b) the size of the outlet opening 22 of either one or both of the chambers 10;
c) length of the surface portions 26 of either one or both of the chambers 10;
d) rotational position of the impact surface 26 of either one or both of the chambers 10 about respective axes 18;
e) the radial distance of the surface portions 26 from the axes 18 of either one or both of the chambers 10.

In one form the sampling system 68 may take the form of a small hole or grate in the wall 66 and an underlying chute 70 with sensors for measuring the size of particles passing through the chute. Alternately a small door can be formed near the downstream end of the surface portion 26 of chamber 10b leading to a sample collection receptacle.

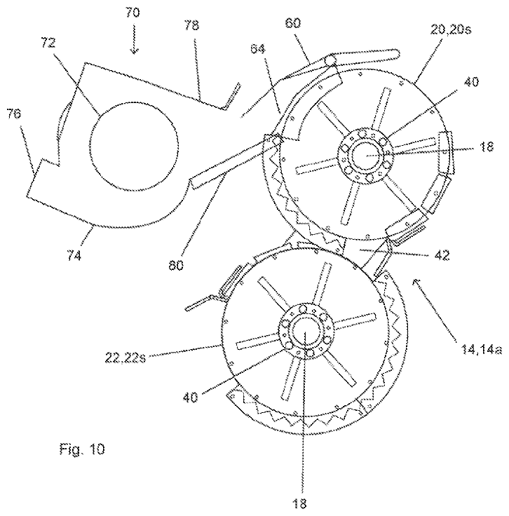

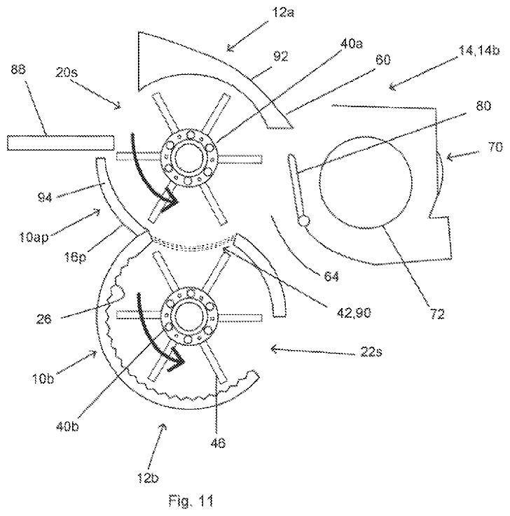

FIG. 10 shows an embodiment of the processing system 14a mounted near a straw processing system 70 on a combine harvester. In this embodiment the processing system comprises the chambers 10a and 10b, with associated rotors 40 in the form of impact mechanism as previously described. The combine harvester includes a separation system (not shown) for separating harvested crop into a target grain which is collected in a sump or tank, a first material stream comprising straw and a second material stream comprising chaff and weed seeds. The form of the separation system is not significant to embodiments of the present disclosure. Any form of separation system to be provided on a combine harvester is suitable for use with embodiments of the chamber 10, machine 12 and system 14a.

The straw processing system 70 may include a straw chopper 72 held within a housing 74 with a discharge opening 76. The housing includes a straw inlet 78 through which the straw passes into the chopper 72; and, a movable chopper housing door 80. The door 80 can be moved by an actuator (not shown) between a closed position and an open position shown in FIG. 10. In one operational arrangement of the chopper 72 and the machine(s) 12/system 14a, where the bypass door 60 is closed and the chopper housing door 80 is closed, the straw is processed by the straw chopper 72 and the chaff is processed by the system 14a. Both processed materials may be: spread separately onto the ground, for example with the processed straw overlying the processed chaff; or, they may be combined in a common spreader (not shown, but also described later) prior to being spread onto the ground. In this operational arrangement the sampling system 68 may also be activated to sample the processed the chaff and provide a measure of weed seed kill.

More specifically in the above operational arrangement:
the straw is fed into the straw chopper 72, chopped into smaller pieces then discharged through the discharge opening 76; and
the chaff is fed into inlet 20s of the system 14a, with weed seeds in the chaff being devitalised by being impacted against the impact surfaces 26 by the respective rotors 40 and discharged through the system outlet 20s.

The straw processing system 70 may also include a straw spreader (not shown) for receiving chopped straw from the discharge opening 76. When a straw spreader is present it is also possible in an embodiment of the system 14a to arrange for the processed chaff exiting from the outlet 22s to be directed into the straw spreader, without passing through the chopper 72. This can be achieved for example by way of a baffle or plate that can be pivoted by action of an actuator operated from a cabin of the combine harvester, to selectively direct the processed chaff and associated air stream into the straw spreader. When processed chaff discharged from the system 14 is directed to the straw spreader, then the straw spreader will spread a mixture of the chopped straw and the processed chaff. In an alternate embodiment, the processed chaff could be fed directly into the straw chopper.

FIGS. 4 and 10 depict a “bypass mode” of the machine 12a and system 14a. In the bypass mode the bypass door 60 is in the open (second) position where material entering the system inlet 20s, exits through the bypass opening 64. When the chopper housing door 80 is also open, then substantially unprocessed chaff is directed into the chopper 70 where it is mixed and discharged with chopped straw via the outlet 76. As a result, the chaff bypasses any substantive processing by the rotors 40 and the impact surfaces 26.

When embodiments of the chamber(s) 10, machine(s) 12 and system 14a are mounted on a combine harvester, a drive system is provided for transferring drive from a motor (i.e., engine or power source of the combine) to the rotors 40 to cause their rotation. This can be achieved by use of pulleys, belts and idler, as is common practice and well-known in the art. For example, as previously mentioned belts, pulleys, shafts and idlers can be coupled with a power take off (PTO) driven by the combine engine to transfer drive to the impact mechanisms 40. The drive systems may alternately or additionally incorporate gearboxes, universal joints, clutches, and shafts. In another variation drive from the combine engine can be delivered to both the straw chopper, and/or straw spreader and the impact mechanisms 40 by a common belt or by multiple belts and pulleys. When the processing system 14a or machine 12a is in the bypass mode power to the machines 12a and 12b, i.e., the system 14 can be halted to reduce power draw from the combine. This can be done by for example by disengaging a clutch on an input drive shaft to the rotor(s) 40.

FIG. 11 shows a further embodiment of the material processing system 14b mounted on a combine harvester. In this embodiment the same reference numbers are used to denote the same features as in the embodiment shown in FIG. 10.

A sieve 88 of the harvester is shown in FIG. 11 leading to an inlet opening 20s of the material processing system 14b. The chaff produced by the combine harvester progresses along the sieve 88 allowing target grain to pass through the sieve for collection. The remaining chaff which includes weed seeds enters the material processing system 14b through the inlet opening 20s. The processing system 14b comprises a chamber 10ap with a rotor 40a that is rotatably supported about a first axis 18a, and a second chamber 10b with a rotor 40b that is rotatably supported about a second axis 18b. The chamber 10ap has a body 16p of a configuration different to that of earlier embodiments. Here the body 16p has an upper cowling 92 spaced from a lower section 94. The space between the upper cowling 92 and the lower section 94 on one side forms the inlet opening 20s and the space between the upper cowling 92 and the lower section 94 on an opposite side forms a bypass opening 64. There is also a screen 90 in or across the common opening 42 between chambers 10ap and 10b. The screen 90 is formed with a plurality of holes that allow material of a specific size range to fall through the screen 90 to the second chamber 10b. Material that is too large to fall through the screen holes continues this tangential motion about the axis 18a.

Additionally, the screen 90 may be hinged at one end about a pivot pin 94 to move between: a screening position where it act to screen chaff passing across the common opening 42; and, a dump position where the screen pivots downwardly about the pin 94 to move away from the common opening 42 allowing all material entering the inlet 20s to flow through to the chamber 10b. In a modified arrangement the screen may be formed as two-piece screen, hinged at opposite ends that open and close together like a double door. The two-piece screen being open and closed is equivalent in effect to the one-piece screen being in the dump position and screening position respectively.

In this embodiment the rotors 40a and 40b are rotated in the same direction, in this instance the anticlockwise direction looking at the left side of the combine—with left being the front of the combine. Material entering the inlet opening 20s is directed to flow tangentially about the first axis 18a by action of the first rotor 40a toward the screen 90 across the common opening 42. Any material passing through the screen 90 and common opening 42 into the second chamber is directed to flow in a tangential direction about the second axis 18b by the action of the second rotor 40b to the outlet opening 22s and gravity. Material that does not fall through the screen 90 may be directed toward the bypass opening 64. From there the material can pass: into the straw chopper 70 if the door 80 is open; or to a spreader; or, windrowed.

In this embodiment of the system 14b, the chamber 10ap acts primarily as a screening or separating chamber with the purpose of removing non-seed material in the chaff, so that material passing through the screen 90 into the chamber 10b comprises a greater percentage of weed seeds and a lower percentage of non-weed seed material than would otherwise be the case. This allows the chamber 10b and associated machine 12b to be structured in a way to more aggressively devitalise the material/weed seeds. This is because more of the energy is being directed into weed seeds rather than non weed seed material. The “more aggressive” devitalisation can be realised by forming the textured first surface portion 26 of the chamber 10b to be a greater arc length than in the earlier embodiments. For example, in system 14b, and due in part to the rotors 40a and 40b be rotated in the same direction, the first surface portion 26 in the chamber 10b may extend for greater than 180°, such as, 200°, or 225° or 270°.

In the system 14b the chamber 10ap may be formed without a textured first surface portion, so that, the inside surface of the chamber 10ap, apart for the screen 90, is smooth. This is because little or no devitalisation is required to occur within the chamber 10ap. Also, because the purpose of the chambers 10ap and 10b is different, it is possible for the rotors 40a and 40b to be of a different configuration. The rotor 40b may be in the form of the impact mechanism comprising the hammers or flails 46 as described hereinabove. However, the rotor 40a may be of a lighter construction, having paddles rather than hammers, and acting more akin to a fan.

Screen 90 may be adjustable in that the size of its holes can be changed. The enables tuning of the screen 90 and the chamber 10ap in terms of the size of material that passes through the screen 90 and common open 42 into the chamber 10b. The screen may have a fully closed configuration where the holes are all closed so that no material can pass through the common opening 42 into the chamber 10b. In this case all the material will be directed to the bypass opening 64. If the door 80 of the straw processing system 70 open, then all the material entering the inlet 20s is transferred by the action of the rotor 40a into the straw processing system 70.

Screen 90 may be opened fully or removed all together so all material enters chamber 10b. In this instance the rotor 40a operates to accelerate the material towards rotor 40b creating impact speeds greater than either tip velocities of the rotors.

It should be understood that when embodiments of individual chambers 10, or system 14 include a screen 90 across their outlet 22 or common opening 42, the screen 90 may be considered to form a part of the surface of one or both chambers in which case the chamber may be considered to include a pervious surface portion.

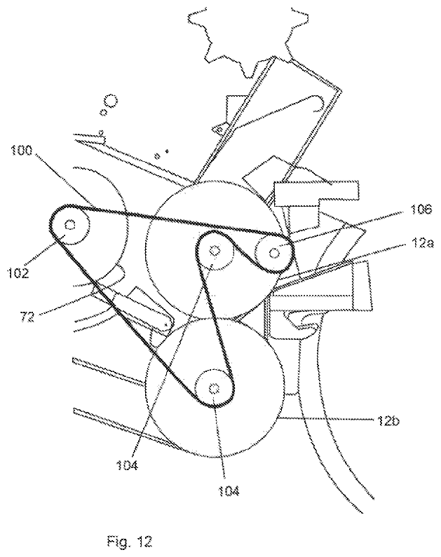

FIG. 12 illustrates one example of drive system for transferring drive from the combine to the rotors 40. In FIG. 12 a belt 100 transfers drive from a pulley 102 on a drive shaft of the straw chopper 72 to pulleys 104 attached to drive shafts of the rotors 40 in the system 14. The belt 100 also runs about an idler pulley 106. In this particular configuration of the belt 100 drives the rotors 40 in counter rotating directions. More specifically the rotors 40 of machine 12a is rotated in an anticlockwise direction, and rotor 40 of machine 12b is rotated in a clockwise direction. Drive to the straw chopper is provided by a further belt and pulley arrangement (not shown) which may transfer drive from a PTO or jack shaft of the combine.

The specific drive system incorporated in embodiments of the system 14 or a combine harvester on which the system 14 is mounted is not a critical or essential aspect of the present disclosure. Nevertheless, the drive system incorporated is arranged to facilitate specific directions of rotation of the rotors 40 as described hereinabove. In one example the drive system may include a reversing gearbox in line with a drive shaft of a pulley for one of the rotors to cause counter rotation of rotors 40 of the chambers 10. Additionally, the drive system may also incorporate a disengagement mechanism such as, but not limited to a clutch, to selectively disengage transmission of drive to the machine(s) 12/rotors 40; and/or, the straw chopper 72. This allows for example the combine harvester to operate with the straw chopper 72 rotating but not the rotors 40.

While several exemplary embodiments have been presented in the foregoing detailed description, it should be appreciated that a vast number of variations exist. For example, a bypass door 60 and first surface portion 26 which is linearly and pivotally moveable is described with reference to FIG. 2. However, in an alternate configuration the first surface portion 26 could be hinged at one end and selectively pivoted about the hinge to also act as a bypass door, thereby doing away with the separate bypass door 60 of the above-described embodiments. In such a variation it is also possible for the hinged first surface portion to move linearly toward or away from the axis 18.

In a further variation, when a separate bypass door is provided, as in the embodiment shown in FIGS. 1-4, the bypass door 60 may be pivotally coupled to the chamber 10a at a different location, or instead of being pivotally coupled can be arranged to move linearly, i.e., in a sliding motion to open and close the bypass opening 64. Also, in the illustrated embodiments when the processing system 14 comprises two rotors 40, they are shown as being mounted on a combine with their axes 18 in a plane that is inclined to or offset from, a plane containing a rotation axis of the straw chopper. But this need not be the case. The machines 12 and processing system 14 may be orientated and mounted on a combine so that bearings for the rotors 40 and the straw chopper are supported in a common plane. Further the machine(s) 12 and material processing system 14 may be mounted on a common housing to that supporting the straw chopper 72.

Also, as previously indicated, embodiments of the system 14 may comprise more than two chambers 10 and associated machines 12. For example, with reference to FIG. 11 a further machine 12 could be coupled with the machine 12b with the inlet of the further machine 12 adjacent to and coincident with the outlet 22s. The outlet opening of the further machine 12 then becomes the outlet of the overall system 14. Such an arrangement will increase the degree of processing of the material by virtue of the additional processing provided by the further machine 12.

It should also be appreciated that the exemplary embodiments of the chamber 10, machine 12 and system 14 are only examples, and are not intended to limit the scope, applicability, or configuration of the present disclosure in any way.

In the claims which follow, and in the preceding description, except where the context requires otherwise due to express language or necessary implication, the word “comprise” and variations such as “comprises” or “comprising” are used in an inclusive sense, i.e., to specify the presence of the stated features but not to preclude the presence or addition of further features in various embodiments of the system and method as disclosed herein.

1. A material processing system comprising:
a first chamber, and a second chamber, an inlet opening to the first chamber, a common opening enabling material to flow from the first chamber to the second chamber, and an outlet opening in the second chamber downstream of the inlet opening and the common opening;
a first rotor rotatably supported about a first axis in the first chamber;
a second rotor rotatably supported about a second axis in the second chamber, wherein the first axis is parallel to the second axis;
wherein the first chamber is an upper chamber of the material processing system and the second chamber is a lower chamber of the material processing system such that the first chamber, the inlet opening and the first axis are above the second chamber, the outlet opening and the second axis respectively; and
wherein material entering the inlet opening is directed to flow tangentially about the first axis by action of the first rotor toward the common opening, and material passing through the common opening into the second chamber is directed to flow in a tangential direction about the second axis by the action of the second rotor to the outlet opening.

2. The material processing system according to claim 1 wherein the second chamber has an inner surface, the inner surface having a textured first surface portion which for a selected arc length about, and radius from, the second axis, has a greater surface area than a sector of the inner surface of the second chamber of a same arc length and radius.

3. The material processing system according to claim 2 wherein the first chamber has an inner surface, inner surface having a first surface portion extending, with reference to a direction of rotation of the first rotor, circumferentially between a first side of the inlet opening to a first side common opening, the first surface portion having a shorter arc length than the textured first surface portion of the second chamber.

4. The material processing system according to claim 3 wherein the first surface portion of the first chamber is a textured first surface portion so that for a selected arc length about and radius from the first axis, the textured first surface portion of the first chamber has a greater surface area than a sector of the inner surface of the first chamber of a same arc length and radius

5. The material processing system according to claim 2 wherein the textured first surface portion is formed with (a) a plurality of valleys or protrusions or both valleys and protrusions; or (b) alternating ridges and grooves; or (c) a wave like pattern of alternating crests and troughs when view in an axial direction.

6. The material processing system according to claim 3 wherein the inner surface of the first chamber has a second surface portion extending from a second side of inlet opening to a second side of the common opening and wherein a radial distance between the first axis and first surface portion of the first chamber is greater than a radial distance between the first axis and the second surface portion of the first chamber.

7. The material processing system according to claim 6 wherein the second surface portion of the first chamber is smooth.

8. The material processing system according to claim 2 wherein the inner surface of the second chamber has a second surface portion extending from a second side of the common opening to a second side of the outlet opening and wherein a radial distance between the second axis and first surface portion of the second chamber is greater than a radial distance between the second axis and the second surface portion of the second chamber.

9. The material processing system according to claim 8 wherein the second surface portion of the second chamber is smooth.

10. The material processing system according to claim 3 wherein the first surface portion of the first chamber is capable of being pivoted about the first axis.

11. The material processing system according to claim 3 wherein the first surface portion of the first chamber is capable of being moved linearly toward or away from the first axis.

12. The material processing system according to claim 3 wherein a second surface portion of the first chamber is capable of being pivoted about the second axis.

13. The material processing system according to claim 1 comprising a bypass door located between the inlet opening and the common opening, wherein the bypass door is movable between a first position and a second position, wherein when in the first position the bypass door acts to direct material entering from the inlet opening toward the common opening, and when in the second position the bypass door opens a bypass opening through which the material can flow out of the first chamber.

14. The material processing system according to claim 13 wherein the bypass door has textured inside surface.

15. The material processing system according to claim 1 comprising a screen extending across the common opening the screen formed with a plurality of holes that allow material of a specific size range to fall through the screen to the second chamber.

16. The material processing system according to claim 15 wherein the screen is adjustable to enable a user selectable fraction of material to pass through the screen to the second chamber.

17. The material processing system according to claim 1 including a screen extending across the common opening, the screen configured to enable particles in the material of a first size to pass through the common opening to the second chamber, and wherein the first chamber includes a bypass opening downstream of the common opening through which material that travels across the screen without falling to the second chamber is discharged from the first chamber.

18. The material processing system according to claim 17 wherein the screen is adjustable to enable a user selectable fraction of material to pass through the screen to the second chamber.

19. The material processing system according to claim 17 wherein a first surface portion of the first chamber is smooth.

20. A material processing system comprising:
a first chamber, and a second chamber, an inlet opening to the first chamber, a common opening enabling material to flow from the first chamber to the second chamber, and an outlet opening in the second chamber downstream of the inlet opening and the common opening;
a first rotor rotatably supported about a first axis in the first chamber;
a second rotor rotatably supported about a second axis in the second chamber, wherein the first axis is parallel to the second axis;
wherein the first chamber is an upper chamber of the material processing system and the second chamber is a lower chamber of the material processing system such that the first chamber, the inlet opening and the first axis are above the second chamber, the outlet opening and the second axis respectively; and
wherein the second chamber has an inner surface, the inner surface having, with reference to a direction of rotation of the second rotor, a first surface portion extending from the common opening to the outlet opening and a second surface portion extending from the outlet opening to the common opening, wherein the first and second surface portions are formed with different surface finishes;
wherein material entering the inlet opening is directed to flow tangentially about the first axis by action of the first rotor toward the common opening, and material passing through the common opening into the second chamber is directed to flow in a tangential direction about the second axis by the action of the second rotor and gravity to the outlet opening.

21. (canceled)

22. (canceled)

23. (canceled)

24. A material processing system comprising:
a first chamber, and a second chamber, an inlet opening to the first chamber, a common opening enabling material to flow from the first chamber to the second chamber, and an outlet opening in the second chamber downstream of the inlet opening and the common opening;
a first rotor rotatably supported about a first axis in the first chamber;
a second rotor rotatably supported about a second axis in the second chamber, wherein the first axis is parallel to the second axis;
a screen extending across the common opening, the screen configured to enable particles in the material of a specific size range to pass through the common opening to the second chamber;
a bypass opening in the first chamber downstream of the common opening with reference to a direction of rotation of the first rotor;
wherein material entering the inlet opening is directed to flow tangentially about the first axis by action of the first rotor toward the common opening, wherein: a first fraction of the material being material of the specific size or smaller passes through the common opening into the second chamber and is directed to flow in a tangential direction about the second axis by the action of the second rotor to the outlet opening; and, a second fraction of the material being material of size that does not pass through the screen is discharged through the bypass opening.

25. (canceled)

26. (canceled)

27. (canceled)

28. The material processing system of claim 24 wherein the common opening and the outlet opening are circumferentially spaced by greater than 1800 measured in the direction of rotation of the second rotor.

29. The material processing system of claim 24 wherein the first rotor is in a form of a fan and the second rotor is in a form of an impact mechanism having hammers or flails for impacting the material passing through the common opening and accelerating the material onto a textured surface.

30. A combine harvester having an engine and a separation system for separating a harvested crop into a first material stream comprising straw and a second material stream comprising chaff and weed seeds, the combine harvester comprising:
a material processing system according to claim 1 wherein the second material stream is directed to flow into the inlet opening of the material processing system; and
a drive system for transferring drive from a motor to the first and second rotors of the material processing system to cause rotation of the first and second rotors.

31. The combine harvester according to claim 30 wherein the drive system comprises a shaft which derives power from the engine and a belt and pulley arrangement having one or more belts and one or more pulleys for transferring drive from the shaft to the first and second rotors.

32. (canceled)

33. (canceled)

34. The combine harvester according to claim 30 further comprising a straw processing system capable of processing the first material stream and discharging a processed first material stream from a discharge location; and wherein a drive transfer system is arranged to transfer drive from the engine to the straw processing system.

35. The combine harvester according to claim 34 wherein the drive transfer system comprises at least one belt arranged to transfer drive from the straw processing system to the material processing system.

36. The combine harvester according to claim 34 wherein the outlet opening of the material processing system is arranged to discharge material from a location beneath the discharge location of the straw processing system.

37. A combine harvester having an engine and a separation system for separating a harvested crop into a first material stream comprising straw and a second material stream comprising chaff and weed seeds, the combine harvester comprising:
a material processing system according to claim 13 wherein the second material stream is directed to flow into the inlet opening of the material processing system; and
a straw processing system capable of processing the first material stream and discharging a processed first material stream from a discharge location; and
wherein the bypass opening is arranged to either direct material: into the straw processing system; or, to be windrowed.

38. The combine harvester according to claim 37 wherein the straw processing system comprises a straw chopper and a straw spreader.

39. The combine harvester according to claim 38 wherein the straw chopper has a door moveable between an open position and a closed position wherein then open position material passing through the bypass opening is able to enter the straw chopper and when in a closed position material passing through the bypass opening is selectively: directed to flow into the straw spreader; or windrowed.

40. The material processing system according to claim 13 wherein chaff is directed by the first and second rotors including by air generated by rotation of the first and second rotors through the bypass door to produce bypassed chaff and wherein the bypassed chaff is (a) directed to flow into a straw chopper; (b) directed into a spreader to be spread together with chopped straw from the straw chopper; or (c) windrowed.
